(19) United States
(12) Patent Application Publication
(10) Pub. No.: US 2006/0067528 A1
(43) Pub. Date: Mar. 30, 2006

(54) Communication device and communication method

(76) Inventor: Yoshio Kimura, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/235,163

(22) Filed: Sep. 27, 2005

(30) Foreign Application Priority Data
Sep. 27, 2004 (JP) 2004-280473

(51) Int. Cl. H04N 7/167

(52) U.S. Cl. 380/201

(57) ABSTRACT

A communication device comprises a decoding unit which encodes a content signal C by an encoding key Kc and outputs an encoded content signal Kc•C, a key encoding unit which encodes the encoding key Kc by use of a static device key k and a dynamic device key K1 stored in advance, and outputs an encoded encoding key k•K1•Kc, communicating units which communicate so as to record the encoded encoding key k•K1•Kc output by the key encoding unit into a predetermined area on a network, and further record in duplication the encoded encoding key together with an encoded content signal Kc•C into a predetermined device on the network, and a key updating unit which updates the stored dynamic device key, when the encoding key Kc is abolished.

### CROSS-REFERENCE TO RELATED APPLICATIONS

This application is based upon and claims the benefit of priority from prior Japanese Patent Application No. 2004-280473, filed Sep. 27, 2004, the entire contents of which are incorporated herein by reference.

### BACKGROUND OF THE INVENTION

1. Field of the Invention

The present invention relates to a communication device such as a television device having network functions, more specifically, to a communication device and a communication method for improving security of video/audio signals via a network by use of encoding/decoding functions.

2. Description of the Related Art

It is known that, in recent years, digital television broadcasting has been promoted. For example, in Japan, in addition to digital satellite broadcasting services such as Broadcasting Satellite (BS) digital broadcasting and 110-degree Communication Satellite (CS) digital broadcasting, but also digital terrestrial broadcasting has been started.

Digital communication devices that receive these digital television broadcasting services enable us to handle video and audio information as digital signals, accordingly it has come to be possible for us to perform easily processes such as recording, replaying, searching and controlling content information, and utilize electronic program information. As an example, in Jpn. Pat. Appln. KOKAI Publication No. 2002-142163, a technology to acquire electronic broadcast program information from the digital television broadcasting and utilize them is disclosed.

However, in Jpn. Pat. Appln. KOKAI Publication No. 2002-142163, there is not any description about how to use digital contents acquired via a network, further, there is no description about any encoding/decoding method that is employed in using the network, which has been a problem in the prior art.

### BRIEF SUMMARY OF THE INVENTION

There is provided a communication device comprising: an encoding unit (81) which encodes given content signals (C) by an encoding key (Kc) and outputs encoded content signals (Kc•C); a key encoding unit (73) which stores a static device key (k) and a dynamic device key (K1) into a storage area (74) in advance, and encodes the encoding key (Kc) by the static device (k) key and the dynamic device key (K1), and outputs an encoded encoding key (k•K1•Kc); a communicating unit (69-72) which performs communications so as to record the encoded encoding key (k•K1•Kc) output by the key encoding unit (73) into a predetermined area (28) on a network, and further record the encoded encoding key in duplication, together with the encoded content signals (Kc•C) encoded by the encoding unit into a predetermined device (25) on the network; a key decoding unit (73) which reads out the encoded encoding key (k•K1•Kc) from the predetermined area via the communicating unit, in response to a replay instruction from a user, and decodes the encoded encoding key into the encoded key (Kc) by the static device key (k) and the dynamic device key (K1); a decoding unit (81) which reads out the encoded content signals (Kc•C) from the predetermined device via the communicating unit, and decodes the encoded content signals into the content signals (C) by the encoding key (Kc) decoded by the key decoding unit; a replaying unit (47) which replays the content signals (C) decoded by the decoding unit; and a key updating unit (73) which updates the stored dynamic device key, when the encoding key (Kc) is abolished.

### BRIEF DESCRIPTION OF THE SEVERAL VIEWS OF THE DRAWING

FIG. 1 is an explanatory diagram schematically explaining an example of a digital television communication device according to one embodiment of the present invention and a network system to be configured therewith;

FIG. 2 is a block diagram showing an example of a configuration of the digital television communication device according to the embodiment of the invention;

FIG. 3 is a block diagram showing an example of a remote control of the digital television communication device according to the embodiment of the invention;

FIG. 4 is a system diagram showing an example of a key control method of the digital television communication device according to the embodiment of the invention;

FIG. 5 is a flow chart for explaining an example of an encoding/decoding process of the digital television communication device according to the embodiment of the invention; and

FIG. 6 is a flow chart for explaining an example of the encoding/decoding process of the digital television communication device according to the embodiment of the invention.

### DETAILED DESCRIPTION OF THE INVENTION

One embodiment according to the present invention will be illustrated in more details with reference to the attached drawings hereinafter.

<Television Device having Network Functions according to the Present Invention>

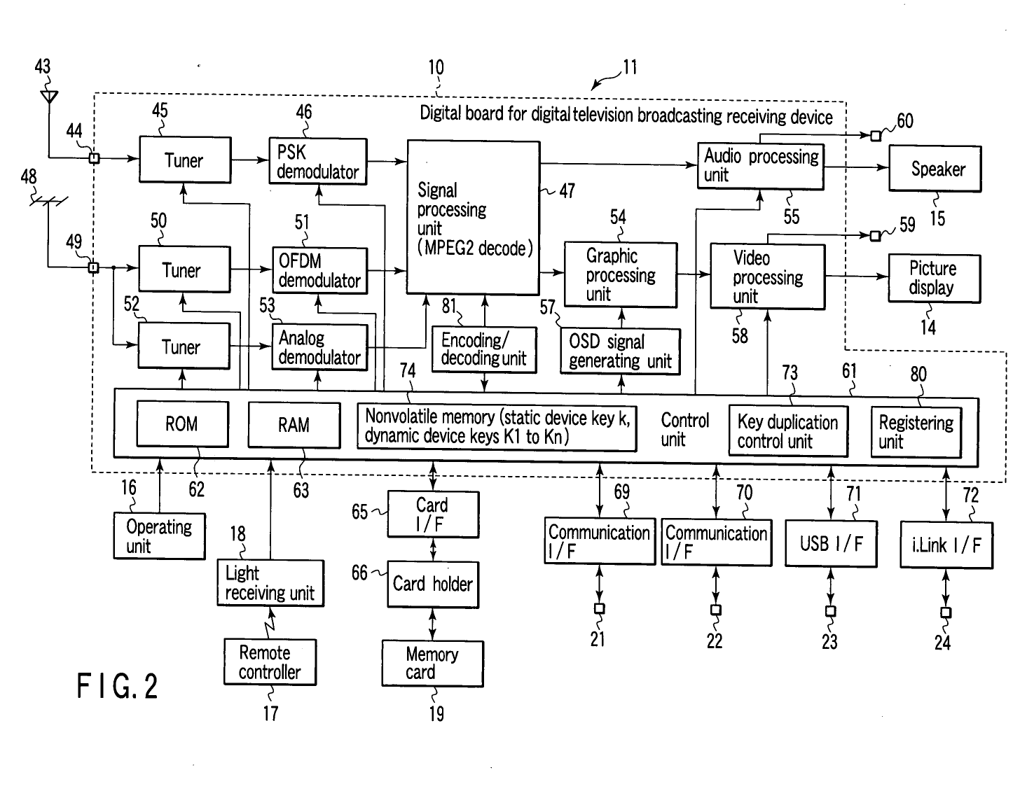

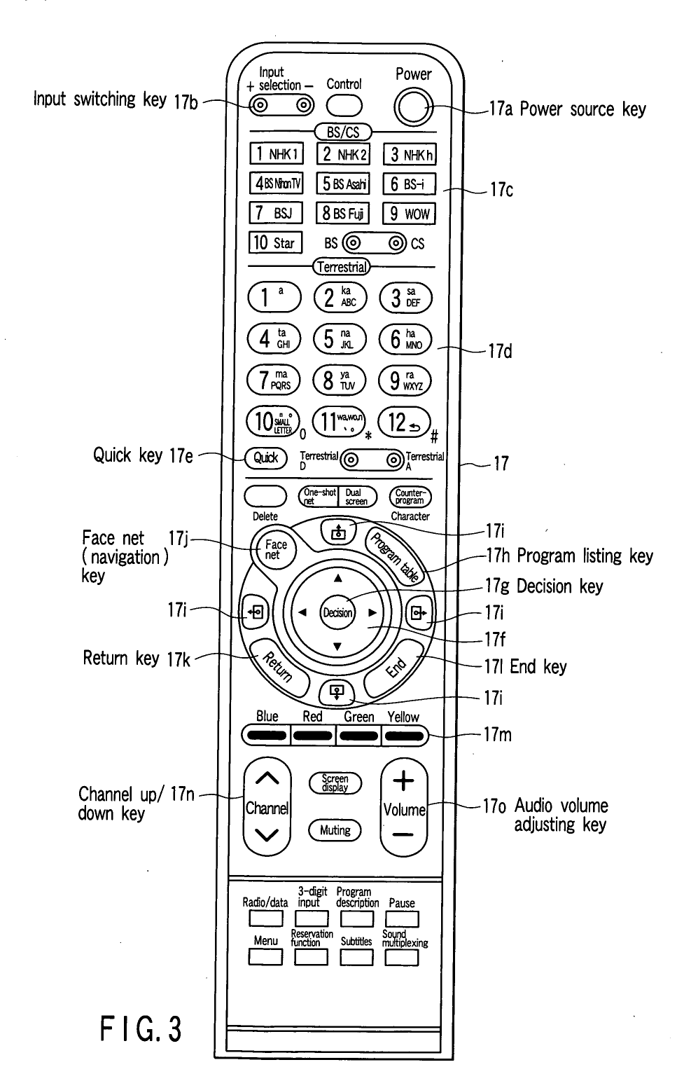

First, an example of a configuration of a television device having network functions as a communication device according to the invention will be explained with reference to the attached drawings hereinafter. FIG. 2 is a block diagram showing an example of a configuration of the digital television communication device according to the embodiment of the invention, and FIG. 3 is a block diagram showing an example of a remote control of the digital television communication device according to the embodiment of the invention.

In concrete, a digital television communication device 11 is mainly composed of a thin cabinet 12, and a supporting stand 13 that supports the cabinet 12 upright. In the cabinet 12, a picture display 14 of a flat panel type comprising, for example, a liquid crystal panel or the like, a speaker 15, an operating portion 16, a light receiving unit 18 that receives operating information sent from a remote control 17, and so forth are arranged.

Further, to the digital television communication device 11, a memory card 19 such as a secure digital (SD) memory card, a multimedia card (MMC) and a memory stick, or, further, a memory card (IC card) where, for example, contract information or so is recorded, may be detachably attached. To these memory cards 19, information of programs and photos and the likes are recorded and replayed, and information is recorded and replayed.

Further, the digital television communication device 11 has a first local area network (LAN) terminal 21, a second LAN terminal 22, a Universal Serial Bus (USB) terminal 23, and an i.Link terminal 24.

Among these terminals, the first LAN terminal 21 is to be used as a LAN-enabled HDD exclusive port, and is used to record and replay information by Ethernet (registered trademark) to a LAN-enabled HDD 25 as a network attached storage (NAS) connected thereto.

As described above, the first LAN terminal 21 as a LAN-enabled HDD exclusive port is arranged, thereby it is possible to stably record program information at Hi-Vision resolution picture quality relative to the HDD 25, without being influenced by other network environments and network use conditions and the like.

The second LAN terminal 22 is to be used as a general LAN-enabled port using Ethernet, and is used to connect, for example, a LAN-enabled HDD 27, a personal computer (PC) 28, a HDD-built-in digital versatile disk (DVD) recorder 29 and the like via a hub 26, and perform information transmission with these devices.

By the way, with regard to the DVD recorder 29, digital information that is transmitted via the second LAN terminal 22 is information for only a control system, accordingly it is necessary to arrange an exclusive analog transmission path 30 in order to perform analog video/audio information transmission with the digital television communication device 11.

Further, the second LAN terminal 22 is used to connect via a broadband router 31 connected to the hub 26, to a network 32 such as, for example, internet, and to perform information transmission via the network 32 with the PC 33 or a cell phone 34 or the like.

The USB terminal 23 is to be used as a general USB-enabled port, and is used to connect via, for example, a hub 35 to a USB device such as a cell phone 36, a digital camera 37, a card reader/writer 38 for a memory card, a HDD 39, and a keyboard 40, and to perform information transmission with these USB devices.

Further, the i Link terminal 24 is used to perform serial interface to, for example, AV-HDD 41. digital-video home system (D-VHS) 42 or the like, and is used to perform information transmission with such devices.

FIG. 2 shows a main signal processing system of the digital television communication device 11. Namely, satellite digital television broadcasting signals received by a BS/CS digital broadcasting receiving antenna 43 are supplied via an input terminal 44 to a satellite digital broadcasting tuner 45, thereby broadcasting signals of a desired channel are selected.

The broadcasting signals selected by the tuner 45 are supplied to a phase shift keying (PSK) demodulator 46, and demodulated to digital video signals and audio signals, and then output to a signal processing unit 47.

Meanwhile, digital terrestrial television broadcasting signals received by a terrestrial broadcasting receiving antenna 48 are supplied via an input terminal 49 to a digital terrestrial broadcasting receiving tuner 50, thereby broadcasting signals of a desired channel are selected.

Broadcasting signals selected by the tuner 50 are supplied to an orthogonal frequency division multiplexing (OFDM) demodulator 51, and demodulated to digital video signals and audio signals, and then output to the signal processing unit 47.

Meanwhile, analog terrestrial television broadcasting signals received by a terrestrial broadcasting receiving antenna 48 are supplied via the input terminal 49 to an analog terrestrial broadcasting receiving tuner 52, thereby broadcasting signals of a desired channel are selected. The broadcasting signals selected by the tuner 52 are supplied to an analog demodulator 53, and demodulated to analog video signals and audio signals, and then output to the signal processing unit 47.

Herein, the signal processing unit 47 selectively performs a predetermined digital signal process, for example, MPEG2 decoding process, to the digital video signals and audio signals supplied from the PSK demodulator 46 and the OFDM demodulator 51 respectively, and outputs processed signals to a graphic processing unit 54 and an audio processing unit 55.

Further, the graphic processing unit 54 has a function to overlay on screen display (OSD) signals generated by an OSD signal generating unit 57, on digital video signals supplied from the signal processing unit 47, and outputs the overlaid signals. The graphic processing unit 54 can selectively output the output video signals of the signal processing unit 47, and the output OSD signals of the OSD signal generating unit 57, or to output both the signals in combination so as to configure half sections of a screen.

The digital video signals output from the graphic processing unit 54 are supplied to a video processing unit 58. The video processing unit 58 converts the input digital video signals into analog video signals of a format for display by the picture display 14, and outputs the signals to the picture display 14 to display them thereon, and also guides the signals via an output terminal 59 to the outside.

Meanwhile, the audio processing unit 55 converts the input digital audio signals into analog audio signals of a format for replay by the speaker 15, and outputs the signals to the speaker 15 to replay them thereby, and also guides the signals via an output terminal 60 to the outside.

Herein, the entire operations of the digital television communication device 11 including the aforementioned various receiving operations are controlled as a whole by a control unit 61. The control unit 61 has a central processing unit (CPU) and the like, and receives the operating information from the operating unit 16, or receives operating information sent from the remote control 17 via the light receiving unit 18, and thereby controls the respective units so as to reflect the operating contents.

In this case, the control unit 61 mainly uses a read only memory (ROM) 62 that stores a control program that the CPU executes, a random access memory (RAM) 63 that supplies work areas to the CPU, and a nonvolatile memory 64 that stores various kinds of setting information and control information and the like.

The control unit 61 is connected via a card interface (I/F) 65 to a card holder 66 to which the memory card 19 may be attached. Thereby, the control unit 61 can perform information transmission with the memory card 19 attached to the card holder 66, via the card I/F 65. Further, the control unit 61 is connected, via a card I/F and a card holder (not shown) to a second memory card that is not illustrated therein but may be attached. Thereby, the control unit 61 can perform information transmission with the second memory card.

Further, the control unit 61 is connected via a communication I/F 69 to the first LAN terminal 21. Thereby, the control unit 61 can perform information transmission with the LAN-enabled HDD 25 connected to the first LAN terminal 21 via the communication I/F 69. In this case, the control unit 61 has a dynamic host configuration protocol (DHCP) server function, and allots an internet protocol (IP) address to the LAN- enabled HDD 25 connected to the first LAN terminal 21 and controls the IP address.

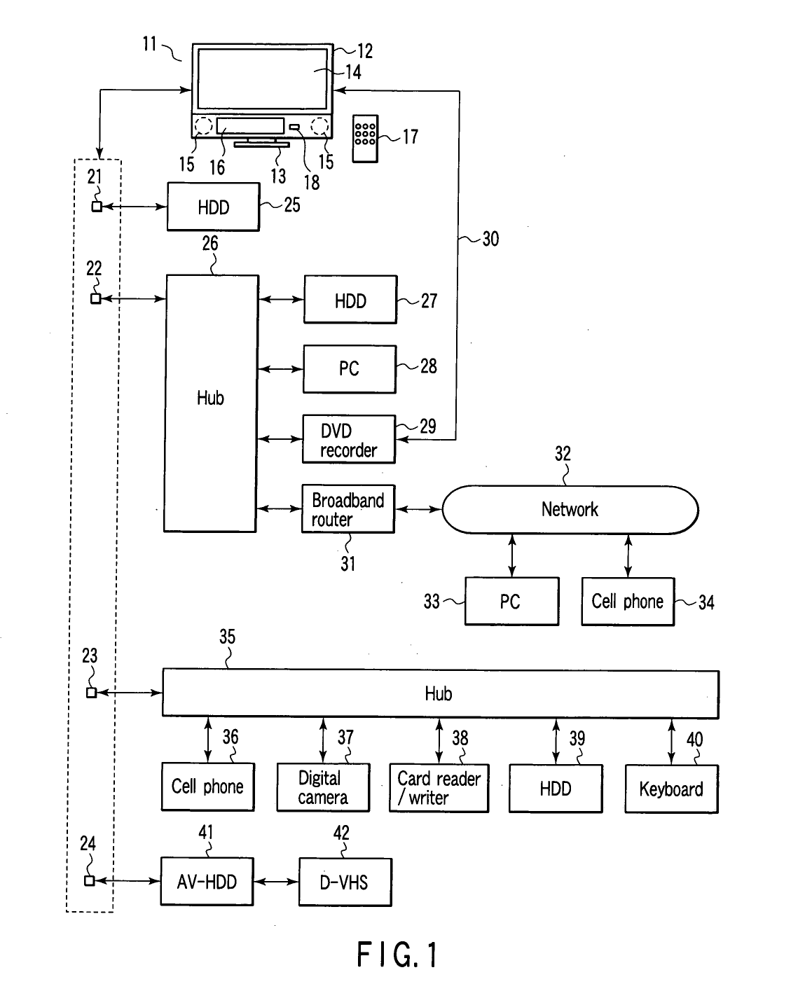

Furthermore, the control unit 61 is connected via a communication I/F 70 to the second LAN terminal 22. Thereby, the control unit 61 can perform information transmission with each device connected to the second LAN terminal 22 (refer to FIG. 1) via the communication I/F 70.

The control unit 61 is connected via a USB I/F 71 to the USB terminal 23. Thereby, the control unit 61 can perform information transmission with each device connected to the USB terminal 23 (refer to FIG. 1) via the USB I/F 71.

Further, the control unit 61 is connected via an i.Link I/F 72 to the i.Link terminal 24. Thereby, the control unit 61 can perform information transmission with each device connected to the i.Link terminal 24 (refer to FIG. 1) via the i.Link I/F 72.

Further, an example of a configuration of a digital board 10 on which the tuners 45, 50 and 52, the demodulators 46, 51 and 53, the control unit 61, the signal processing unit 47 and so forth are loaded is shown in FIG. 2. The configuration of the digital board 10 is just one example, and other circuit may be included therein, further, each block in the figure may not always be arranged in the digital board 10, but may be arranged on other board.

Further, the control unit 61 has a recovery function to recover a key control system after a failure occurs with the digital board 10 and the board is exchanged, a key duplication control unit 73 that controls so as to record an encoded encoding key in plural areas in duplication, in order to control the key control system, a nonvolatile memory 74 that stores a static device key k, dynamic device keys K1 to Kn used for the key control system, and a registering unit 80 that registers a recording replaying device on the network for recording content information from the television communication device 11. Further, for encoding processing and decoding processing, an encoding/decoding unit 81 is arranged to be connected to the signal processing unit 47.

FIG. 3 shows the external appearance of the remote control 17. The remote control 17 mainly has a power source key 17a, an input switching key 17b, satellite digital broadcasting channel direct selection keys 17c, terrestrial broadcasting channel direct selection keys 17d, a quick key 17e, a cursor key 17f, a decision key 17g, a program listing key 17h, page switching keys 17i, a face net (navigation) key 17j, a return key 17k, an end key 17l, blue, red, green, and yellow color keys 17m, a channel up/down key 17n, an audio volume adjusting key 17o, a menu key 17p and so forth.

(Encoding Key System)

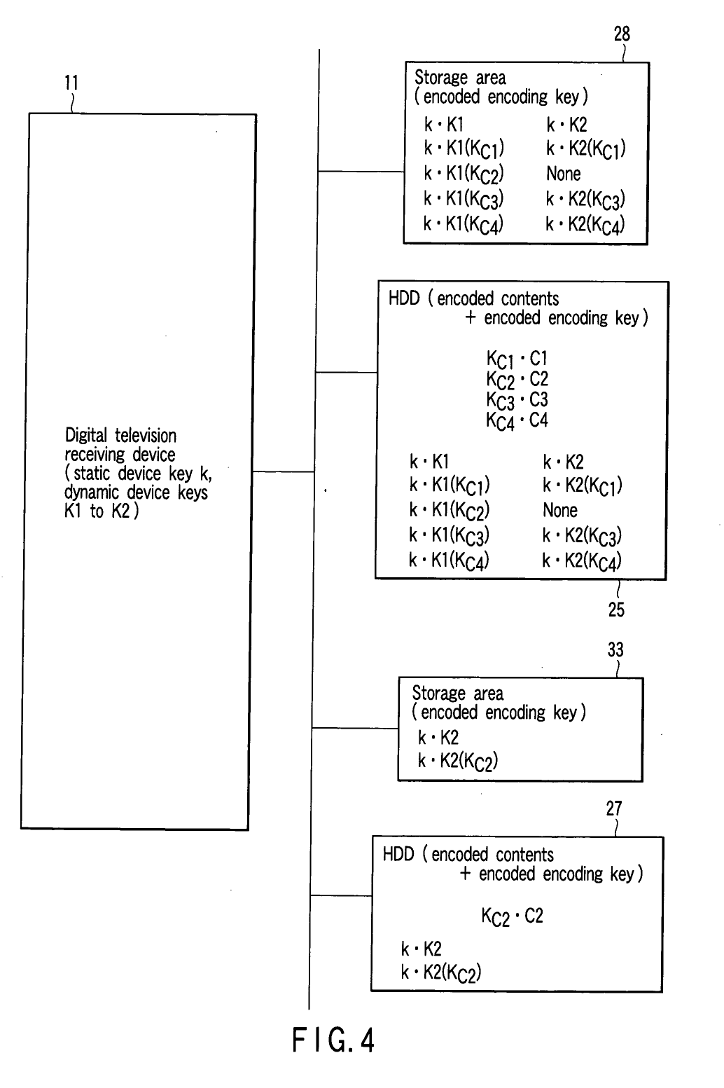

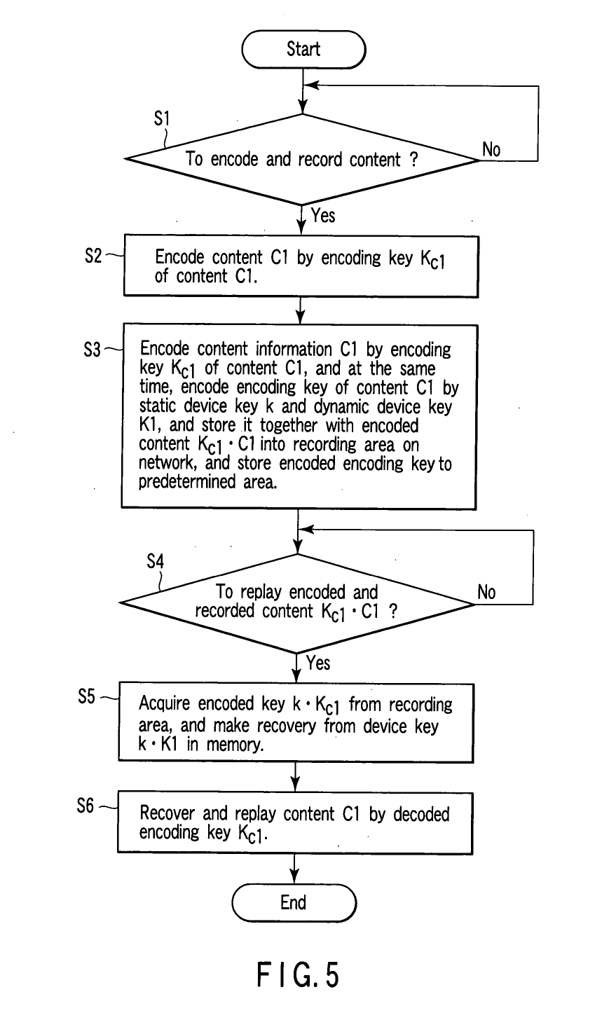

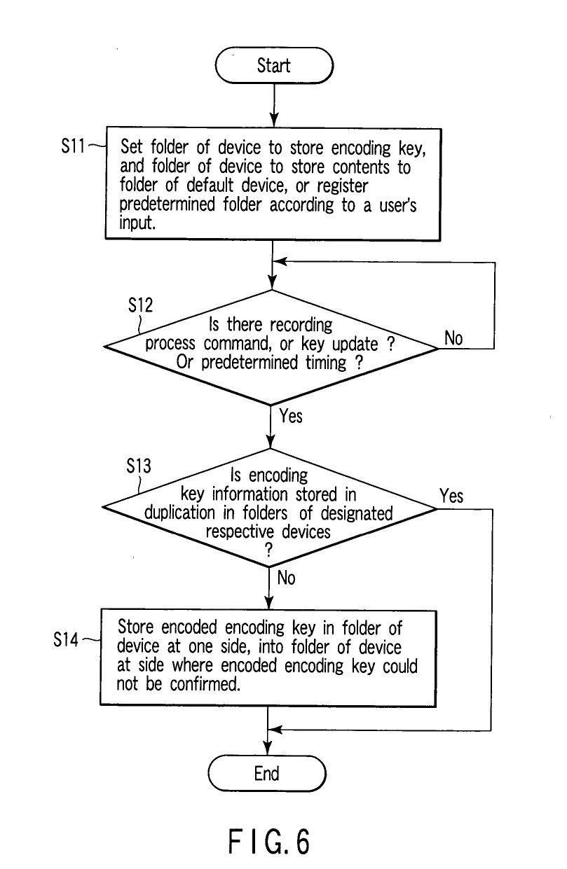

Next, a decoding/encoding system of content information according to the network in the digital television communication device is explained in detail with reference to the drawings. FIG. 4 is a system diagram showing an example of a key control method of the digital television communication device according to the embodiment of the invention, FIG. 5 is a flow chart for explaining an example of encoding/decoding process of the digital television communication device according to the embodiment of the invention, and FIG. 6 is a flow chart for explaining an example of an encoding/decoding process of the digital television communication device according to the embodiment of the invention.

Namely, in the communication device, which is a television device having, for example, network functions, when content information C corresponding to digital broadcasting signals is transferred and recorded to, for example, the HDD 25 or the like on the network as one example, the encoding/decoding process is performed. Namely, the content information is encoded by the encoding key Kc into encoded content information Kc•C that is transferred and recorded to a hard disk recorder or the like.

At this moment, the encoding key Kc served for encoding is encoded by two keys of the static device key k and the dynamic device key K1 to stored in the nonvolatile memory 74 and the like, and stored into the predetermined area 28 of a PC, a hard disk and the like on the network, as an encoded encoding key k•K1•Kc.

As explained above, the encoding key Kc of content information is encoded and stored on the network, and the content information is also encoded and recorded to a device on the network, thereby it is possible to store data on the network in safe manners. The encoding key (Kc) of the content information is not particularly stored at the television device side, and when. the content information is to be decoded, the content information is acquired from the network once again.

Namely, in the television device, or in the device on other network, when content information is to be replayed, the encoded encoding key (k•K1•Kc) and the encoded content information (Kc•C) are recollected from the network again, further, by two keys of the static device key (k) and the dynamic device key (K1 to) stored in the nonvolatile memory 74 and the like, the encoding key (Kc) of the content information is recovered. By the recovered encoding key (Kc), the encoded content information (Kc•C) is recovered, and used for replaying processing.

Herein, the static device key (k) is an encoding key corresponding to a circuit board whose contents are not changed, on the other hand, the dynamic device keys (K1 to Kn) are ones whose value is updated from K1 to K2, from K2 to K3, at every time when the key is disabled, for example, along movement or deletion of the content information. The update information of the dynamic device key is updated in the nonvolatile memory 74 of the television device, updated in the history of the encoded encoding key (k•K1•Kc . . . ) in the predetermined area 28 on the above mentioned network. Thereby, it becomes possible to freely move content information whose copying is prohibited, while protecting security and copyright on the network.

Next, with reference to the system diagram in FIG. 4 and the flow chart in FIG. 5, the encoding process and the decoding process are explained in time series manner. Namely, in the digital television broadcasting receiving device 11, when there is an instruction signal or the like to encode and record content information on the basis of the control of the control unit 61 and the key duplication control unit 73 (S1), content information C1 is encoded by an encoding key Kc₁ of the content information C1 (S2). At this moment, the content information is an output where broadcasting signals selected by the tuners 45, 50, 52 and the likes are demodulated by the demodulators 46, 51, 53 and the likes, and further processed, in the signal processing unit 47, for example, for MPEG2 decoding. It is preferable that the content information is one given from, for example, the respective interfaces 69 to 72. Next, the content information C1 is encoded by an encoding key Kc₁ of the content information C1. Herein, it is preferable to create the encoding key Kc₁ at every time by a key generating unit (not shown), but the present invention is not limited to this. It is not always necessary to store the created encoding key Kc₁, but it is basically to be stored on the network.

Next, the encoded content Kc₁•C1 encoded by the encoding key Kc₁ is recorded to, for example, the HDD 25 on the network registered by the registering unit 80 (S3). At the same time with this, the encoding key Kc₁ is also encoded by the static device key k and the dynamic device key K1, into an encoded encoding key k•K1•Kc₁, and transferred and stored via the communication I/F unit 69 to, for example, the hard disk drive 28 on the network registered by the registering unit 80 (S3). However, in the communication I/F unit 69 and the like as the communication unit and the like, authorization process with devices on the network is performed, and after authorization succeeds, encoded content signals and encoded encoding keys are sent out.

At this moment, in the present embodiment, the above encoded encoding key k•K1•Kc₁ is recorded to, for example, the PC 28 on the network registered by the registering unit 80, and, for example, the HDD 25 and the like as the recording destinations where the encoded content Kc₁•C1 and the like are recorded in duplication. By recording the encoded encoding key k•K1•Kc₁ to plural portions as described above, even when there occurs a fault with, for example, the PC 28, it becomes possible to secure the encoded encoding key k•K1•Kc₁ by other HDD 25 and the like, accordingly operating stability of the encoding system may be attained. Further, the number of the recording destinations is not limited to two, but by recording to more areas in duplication, it is possible to improve the system reliability.

Next, in the case of replaying the encoded and recorded content information Kc₁•C1 by a command from a user or the like (S4), from, for example, the PC 28 as the recording area registered by the registering unit 80, the encoded encoding key k•K1•Kc₁ is acquired, and recovery is performed from the static device key k and the dynamic device key K1 in the nonvolatile memory 74 (S5). By the recovered encoding key Kc₁, the encoded content information Kc₁•C1 acquired from the HDD 25 and the like via the communication I/F 69 as the communication unit is decoded and replayed (S6).

By the way, the key duplication control unit 73 as the key updating unit, at movement or deletion of a content signal (for example, C2) thereafter, changes the dynamic device key K1 of the storage area 74 into a new dynamic device key K2, in order to make the encoded content signal (for example, C2) on the network undecodable thereby make it unreplayable. As shown in FIG. 4, as the encoded encoding key in the hard disk driver 25 on the network, encoded encoding keys (k•K1•Kc₁, k•K2•Kc₃, and k•K2•Kc₄) corresponding to all the currently replayable encoded content signals (for example, C1, C3, and C4) are recorded. Thereby, other content information than the content information C2 that is to be unreplayable becomes replayable even after the dynamic device key is updated.

(Confirmation Operation of Encoded Encoding Key)

Next, confirmation operation and recovery operation of the encoded encoding key k•K1•Kc₁ and the like are explained in detail with reference to the flow chart in FIG. 6. The encoded encoding key k•K1•Kc₁ is stored in plural portions on the network, meanwhile it may become unreadable owing to a device failure or deletion by mistake or so. Herein, it is confirmed that the encoded encoding key k•K1•Kc₁ exists at a predetermined timing, and if it is unreadable, then it is automatically recovered to be readable.

In concrete, in the flow chart in FIG. 6, first, the folder of the device to store the encoded encoding key k•K1•Kc₁, and the folder of the device to store contents are set to the folder of a preset default device, or a predetermined folder of the device registered in the registering unit 80 according to a user's input (S11). At a command of the recording process from user, or, along with deletion or movement of contents, at an update timing of the key information, or, at a predetermined timing preset by user or the like or set by default, for example, according to time and date, it is judged whether a predetermined timing such as once a day, once a week or so is attained or not (S12).

If it is confirmed that the desired timing has been attained, it is confirmed whether the encoded encoding key k•K1•Kc₁ and the like are securely recorded to be read in the desired folder of the device designated by the registering unit 80 and the like (S13). If they do not exist to be readable, recovery is made by recording encoded encoding key k•K1•Kc₁ and the like in the folder of the device at one side, into the folder of the device at the side where reading could not be confirmed (S14). In this manner, the encoded encoding key k•K1•Kc₁ and the like are confirmed at the predetermined timing, and recovered at necessity, thereby, it is possible to make the operations of the encoding system reliable, and to perform communications of content information via the network with a high level of security.

As explained above, the communication device is, for example, a television device having network functions, and when to transfer and record content information (C) corresponding to digital broadcasting signals to, for example, the DVD recorder (25) or the like on the network as one example, the content information is encoded by the encoding key (Kc) into encoded content information (Kc•C), and transferred and recorded to a hard disk recorder or the like.

At this moment, the encoding key (Kc) served for encoding is encoded by two keys of the static device key (k) and the dynamic device key (K1 to) stored in the nonvolatile memory 74 and the like, into the encoded encoding key (k•K1•Kc₁), and stored into the predetermined area (28) of a PC or a hard disk or the like on the network.

By the way, in the embodiment of the invention, the encoded encoding key is not only stored to one portion in a hard disk on the network or the like, but also stored in duplication to, for example, a DVD recorder device or a PC or the like where at least encoded content information is stored. Thereby, even if a hard disk recorder as the storage destination of the encoded encoding key becomes faulty and the key becomes unreadable, the encoding system will not become inoperative.

As explained above, the encoding key of content information is encoded and stored on the network, and the content information is also encoded and recorded in devices on the network, thereby it is possible to store data on the network in safe manners. Further, the encoding key (Kc) of content information is not particularly stored at the television device side, and when to decode the content information, the encoding key is acquired from the network once again.

In concrete, in the television device, when content information is to be replayed, the encoded encoding key (k•K1•Kc) and the encoded content information (Kc•C) are recollected from the network again, further, by two keys of the static device key (k) and the dynamic device key (K1 to) stored in the nonvolatile memory 74 and the like, the encoding key (Kc) of the content information is recovered. By the recovered encoding key (Kc), the encoded content information (Kc•C) is recovered, and used for replaying processing.

Herein, the static device key (k) is an encoding key corresponding to a circuit board whose contents are not changed, on the other hand, the dynamic device keys (K1 to Kn) are ones whose value is updated from K1 to K2, from K2 to K3, at every time when the key is disabled, for example, along movement or deletion of the content information. The update information of the dynamic device key is updated in the nonvolatile memory 74 of the television device, and updated in the history of the encoded encoding key (k•K1•Kc . . .) in the predetermined area (28) on the above mentioned network as well. Thereby, it becomes possible to freely move content information whose copying is prohibited, while protecting security and copyright on the network.

Furthermore, in the embodiment of the invention, it is confirmed whether the encoded encoding key (k•K1•Kc₁) exists reliably in plural areas at a predetermined timing, and if it is unreadable at one side, then it is automatically recovered to be readable. Thereby, it is possible to perform the key control of the encoding system precisely, and operate the encoding system reliably.

Through the various embodiments mentioned above, those skilled in the art may realize the present invention, further, it is easy for those skilled in the art to hit upon various modifications of these embodiments, and apply them to various embodiments without having innovative capability. Accordingly, the present invention expands to a wide scope of embodiments that do not conflict the principle and novel features disclosed herein, and is not limited to the above-mentioned embodiments.

What is claimed is:

1. A communication device comprising:
an encoding unit which encodes given content signals by an encoding key and outputs encoded content signals;
a key encoding unit which stores a static device key and a dynamic device key into a storage area in advance, and encodes the encoding key by the static device key and the dynamic device key, and outputs an encoded encoding key;
a communicating unit which performs communications so as to record the encoded encoding key output by the key encoding unit into a predetermined area on a network, and further record the encoded encoding key in duplication, together with the encoded content signals encoded by the encoding unit into a predetermined device on the network;
a key decoding unit which reads out the encoded encoding key from the predetermined area via the communicating unit, in response to a replay instruction from a user, and decodes the encoded encoding key into the encoded key by the static device key and the dynamic device key;
a decoding unit which reads out the encoded content signals from the predetermined device via the communicating unit, and decodes the encoded content signals into the content signals by the encoding key decoded by the key decoding unit;
a replaying unit which replays the content signals decoded by the decoding unit; and
a key updating unit which updates the stored dynamic device key, when the encoding key is abolished.

2. A communication device according to claim 1, further comprising:
a key duplication control unit which confirms whether the encoded encoding key is recorded in duplication to the predetermined area and the predetermined device on the network respectively, and when the encoded encoding key is not recorded in one side, then reads out the encoded encoding key of the side where the encoded encoding key is recorded, and records the encoded encoding key to the side where the encoded encoding key is not recorded.

3. A communication device according to claim 1, further comprising:
a registering unit which registers the predetermined device on the network to repeatedly record the content signals, and registers the predetermined area on the network to repeatedly record the encoded encoding key; and
a key duplication control unit which confirms whether the encoded encoding key is recorded in duplication to the predetermined area and the predetermined device on the network respectively, and when the encoded encoding key is not recorded in one side, then reads out the encoded encoding key of the side where the encoded encoding key is recorded, and records the encoded encoding key to the side where the encoded encoding key is not recorded.

4. A communication device according to claim 3, wherein the key updating unit, at movement or deletion of the content signals thereafter, changes the dynamic device key of the storage area into a new dynamic device key, in order to make the encoded content signals on the network undecodable thereby make it unreplayable, and further, records the encoded encoding keys corresponding to all the currently replayable encoded content signals into the predetermined area on the network.

5. A communication device according to claim 1, wherein the storage area which stores the static device key and the dynamic device key is a nonvolatile memory.

6. A communication device according to claim 1, further comprising:
a tuner unit which receives broadcasting signals and selects a channel and outputs a channel selection signal; and
a demodulating unit which demodulates the channel selection signal from the tuner unit, and supplies obtained video/audio signals as the content signals to the encoding unit.

7. A communication device according to claim 6, further comprising:
a signal processing unit which supplies the video-audio signals obtained by MPEG decoding of the video/audio signals output by the demodulating unit as the content signals to the encoding unit.

8. A. communication device according to claim 1, wherein the communicating unit performs an authorization process with the predetermined device on the network and the device which supplies the predetermined area, and sends the encoded content signals or the encoded encoding key after the authorization succeeds.

9. A communication device according to claim 1, wherein the communicating unit includes at least one of a LAN, a USB terminal, and an i.Link terminal.

10. A communication method comprising:
encoding given content signals by an encoding key and outputting encoded content signals;
storing a static device key and a dynamic device key into a storage area in advance, and encoding the encoding key by the static device key and the dynamic device key, and outputting an encoded encoding key;
performing communications so as to record the encoded encoding key into a predetermined area on a network, and further record the encoded encoding key in duplication, together with the encoded content signals encoded by the encoding unit into a predetermined device on the network;
reading out the encoded encoding key from the predetermined area, in response to a replay instruction from a user, and decoding the encoded encoding key into the encoded key by the static device key and the dynamic device key;
reading out the encoded content signals from the predetermined device via the communicating unit, and decoding the encoded content signals into the content signals by the encoding key decoded by the key decoding unit;
replaying the content signals decoded by the decoding unit; and
updating the stored dynamic device key, when the encoding key is abolished.

11. A communication method according to claim 10, further comprising:
confirming whether the encoded encoding key is recorded in duplication to the predetermined area and the predetermined device on the network respectively, and when the encoded encoding key is not recorded in one side, then reading out the encoded encoding key of the side where the encoded encoding key is recorded, and recording the encoded encoding key to the side where the encoded encoding key is not recorded.

12. A communication method according to claim 10, further comprising:
registering the predetermined device on the network to repeatedly record the content signals, and registering the predetermined area on the network to repeatedly record the encoded encoding key; and
confirming whether the encoded encoding key is recorded in duplication to the predetermined area and the predetermined device on the network respectively, and when the encoded encoding key is not recorded in one side, then reading out the encoded encoding key of the side where the encoded encoding key is recorded, and recording the encoded encoding key to the side where the encoded encoding key is not recorded.

13. A communication method according to claim 12, wherein, at movement or deletion of the content signals thereafter, the dynamic device key of the storage area is changed into a new dynamic device key, in order to make the encoded content signals on the network undecodable thereby make it unreplayable, and further, the encoded encoding keys corresponding to all the currently replayable encoded content signals are recorded into the predetermined area on the network.

14. A communication method according to claim 10, wherein the storage area which stores the static device key and the dynamic device key is a nonvolatile memory.

15. A communication method according to claim 10, further comprising:
receiving broadcasting signals and selecting a channel and outputting a channel select signal, and supplying video/audio signals obtained by demodulating the channel select signal as the content signals to the encoding step.

16. A communication method according to claim 15, further comprising:
supplying the video-audio signals obtained by MPEG decoding the video/audio signals as the content signals to the encoding step.

17. A communication method according to claim 10, further comprising:
performing an authorization process with the predetermined device on the network and the device which supplies the predetermined area, and sending the encoded content signals or the encoded encoding key after the authorization succeeds.

18. A communication method according to claim 10, wherein the communicating process uses at least one of a LAN, a USB terminal, and an i.Link terminal.
